(19) United States
(12) Patent Application Publication
(10) Pub. No.: US 2015/0212726 A1
(43) Pub. Date: Jul. 30, 2015

(54) INFORMATION PROCESSING APPARATUS AND INPUT CONTROL METHOD

(71) Applicant: FUJITSU LIMITED, Kawasaki-shi (JP)

(72) Inventor: TAKASHI YAMASAKI, Kawasaki (JP)

(21) Appl. No.: 14/578,743

(22) Filed: Dec. 22, 2014

(30) Foreign Application Priority Data
Jan. 24, 2014 (JP) 2014-011274

(51) Int. Cl. G06F 3/0488; G06F 3/0482; G06F 3/041; G06F 3/0484

(52) U.S. Cl. CPC G06F 3/04883; G06F 3/04886; G06F 3/04842; G06F 3/0482; G06F 3/0418

(57) ABSTRACT

An information processing apparatus including a display unit configured to display a virtual keyboard and a character representation area for displaying a character, a detection unit configured to detect a touch input to the virtual keyboard, and a control unit configured to display a character in the character representation area according to the detected touch input to the virtual keyboard, wherein when the detection unit detects a sliding operation starting from a predetermined key of the virtual keyboard, the control unit selects from among characters displayed in the character representation area at least one character according to the number of characters determined by a distance between the predetermined key and a touch position of the sliding operation and then deletes the selected character when the detention unit detects that the sliding operation is completed.

### CROSS-REFERENCE TO RELATED APPLICATION

This application is based upon and claims the benefit of priority of the prior Japanese Patent Application No. 2014-011274, filed on Jan. 24, 2014, the entire contents of which are incorporated herein by reference.

### FIELD

The embodiments described herein are related to an information processing apparatus and an input control method.

### BACKGROUND

Information processing apparatuses such as popular mobile phone terminals include smartphones and tablets with touch panels for users to perform various operations with fingers. It is desirable for the information processing apparatuses to improve the user operability for various touch panel operations. And the information processing apparatuses employ text input functions called software keyboard which is also referred to as softkey for drafting emails etc.

Applications using software keyboard employed in smartphones etc. include applications which enable text input and text editing in text editors, mailers and browsers etc., which are referred to as editors. When a plurality of characters which have been input are deleted in such editors, the backspace key is touched as many times as the number of characters to be deleted.

Thus, users check the characters currently displayed on the screen and touch the backspace key to delete the characters one at a time when a plurality of characters are deleted.

Techniques proposed to enhance the operability of the software keyboard for deleting characters include functions of supporting text input. Conventionally, users touch keys of the software keyboard such as backspace key and delete key and move a finger to swipe and slide etc. when a plurality of characters are deleted as a whole.

The following patent documents describe conventional techniques related to the techniques described herein.

### PATENT DOCUMENT

[Patent document 1] Japanese Laid-Open Patent Publication No.2013-20652

### SUMMARY

According to one embodiment, it is provided an information processing apparatus including a display unit configured to display a virtual keyboard and a character representation area for displaying a character, a detection unit configured to detect a touch input to the virtual keyboard, and a control unit configured to display a character in the character representation area according to the detected touch input to the virtual keyboard, wherein when the detection unit detects a sliding operation starting from a predetermined key of the virtual keyboard, the control unit selects from among characters displayed in the character representation area at least one character according to the number of characters determined by a distance between the predetermined key and a touch position of the sliding operation and then deletes the selected character when the detention unit detects that the sliding operation is completed.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram schematically illustrating a hardware configuration of a mobile terminal device according to an embodiment;

FIG. 2 is a functional structure diagram illustrating functional parts of the mobile terminal device according to the present embodiment;

FIG. 3 is a flowchart illustrating an example of processes performed by the mobile terminal device according to the present embodiment;

FIG. 4 is a timing chart illustrating an example of processes performed by the mobile terminal device according to the present embodiment;

FIGS. 5A to 5D is are a schematic diagrams illustrating an example of operations and display of the mobile terminal device according to the present embodiment.

### DESCRIPTION OF EMBODIMENTS

In the techniques as described above, users can delete a plurality of characters as a whole according to the length of sliding of a finger etc. on the touch panel. However, when users mistakenly move the finger etc. in the wrong way to delete more characters than the users intend, the users input the deleted characters again. It is an aspect according to the embodiments disclosed herein to provide an information processing apparatus for deleting characters with preferable accuracy which users intend to delete. First, an information processing apparatus according to an embodiment is described below with reference to the drawings.

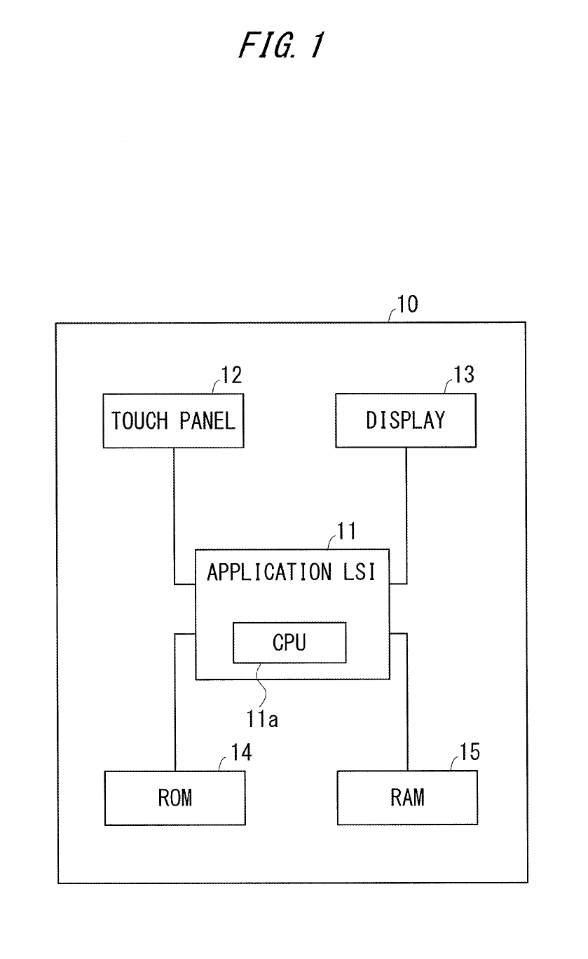

As illustrated in FIG. 1, a mobile terminal device 10 as an example of the information processing apparatus according to the present embodiment includes an application LSI (Large-scale Integrated Circuit) 11, a touch panel 12, a display 13, ROM (Read-Only Memory) 14 and RAM (Random Access Memory) 15. In addition, the application LSI 11 includes a CPU (Central Processing Unit) 11a.

Memory and hardware dedicated for image processing etc. are consolidated on application LSI 11. When a variety of software is executed on the application LSI 11, various processes including character input and image processing are performed.

The touch panel 12 detects a touch of a finger etc. of a user. Data generated as a result of the detection by the touch panel 12 is subject to signal amplification, conversion from current signal to voltage signal, denoising and the like performed by an AFE (Analog Front End) (not illustrated) and then is sent to the application LSI 11. The application LSI 11 performs coordinate operations based on touch points detected by the touch panel 12. The application LSI 11 performs image drawing processes on the display 13 based on the calculation results of the coordinate operations. The touch panel 12 is layered onto the display 13. The user, for example, selects items displayed on the display 13 by touching the touch panel 12 with a finger etc.

The ROM 14 stores various software executed on the application LSI 11. The software stored in the ROM 14 is called by the application LSI 11 and run by the CPU 11a. In addition, the RAM 15 is used for deploying software read from the ROM 14 and storing result data of operations performed by the CPU 11a.

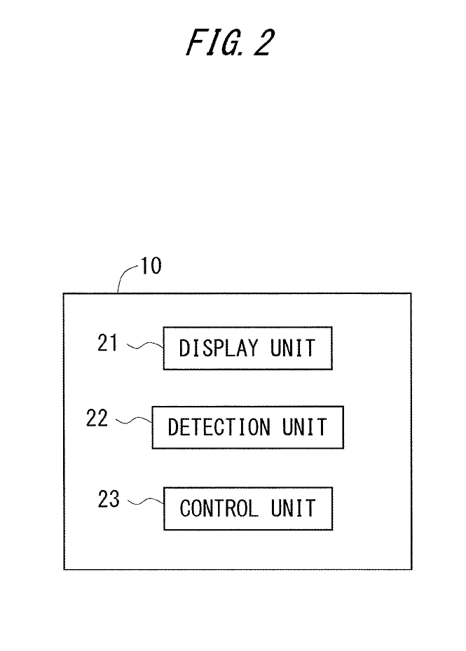

As illustrated in FIG. 2, when the mobile terminal device 10 according to the present embodiment deploys programs stored in the ROM 14 onto the RAM 15 and instructs the CPU 11a to execute the programs, the mobile terminal device 10 functions as an information processing apparatus including a display unit 21, a detection unit 22 and a control unit 23. For example, the display 13 functions as the display unit 21 to perform displaying a software keyboard and characters etc. In addition, the touch panel 12 functions as the detection unit 22 to detect touch points of touch operations and various gestures performed by a finger etc. of the user. Further, the CPU 11a, for example, functions as the control unit 23 to control displaying characters on the display unit 21 based on the touch inputs detected by the detection unit 22.

It is noted that the processes performed by the CPU 11a are not limited to the processes allocated to the units as described above. In addition, any one or more of the display unit 21, the detection unit 22 and the control unit 23 can be achieved by a hardware circuit to perform at least part of the processes as described above.

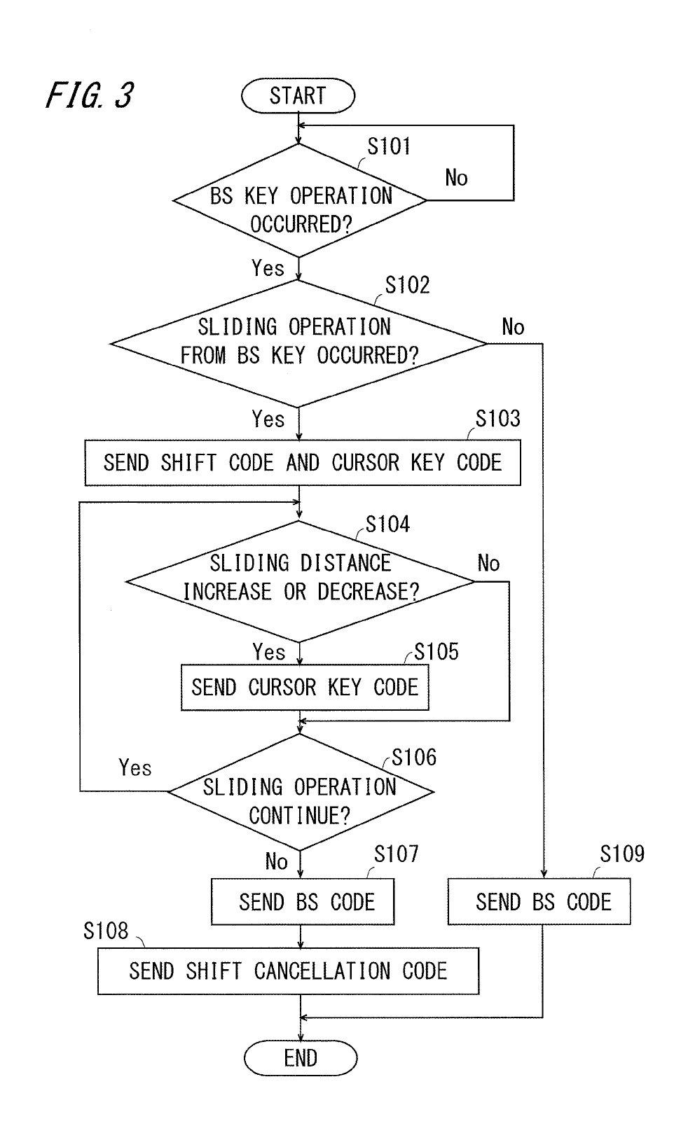

FIG. 3 illustrates a flowchart of processes for deleting characters performed by the mobile terminal device according to the present embodiment. In the following descriptions, each step is denoted by S. In the present embodiment, the processes of the flowchart are initiated when, for example, the application LSI 11 executes text editing software and the software keyboard is activated by the application LSI 11. Each process in the flowchart as illustrated in FIG. 3 is performed by the CPU 11a.

The processes performed as described below in the present embodiment can be achieved by adding functions to the software keyboard without modifying the architectures of the applications such as text editing software etc. Therefore, the functions achieved in the present embodiment can be implemented in the mobile terminal device by combining the existing codes of the software keyboard and the codes of the additional functions without modifying the codes of the application.

First, when the application LSI 11 activates the software keyboard, a virtual keyboard for editing such as inputting and deleting characters is displayed on the display 13. The layout of the virtual keyboard is constructed in accordance with the language environment used in the mobile terminal device 10 and displayed on the display 13. For example, in Japanese environment, a keyboard for inputting kana characters and a keyboard for inputting Roman alphabet can be displayed on the display 13 according to the user preferences. Since the virtual keyboard is conventional, the descriptions of the details of the virtual keyboard are omitted here.

The user manipulates each key of the virtual keyboard displayed on the display 13 to perform various text editing functions of the running text editing software. And, in the present embodiment, the processes for deleting characters as described below can be achieved based on the operations of a so-called backspace (BS) key used for deleting input characters. As illustrated in FIG. 3, the CPU 11a determines in S101 whether or not an operation occurs to the BS key of the virtual keyboard. For example, the CPU 11a determines whether or not the user touches the BS key based on the result of the detection of a touch point by the touch panel 12. When the CPU 11a determines that an operation does not occur to the BS key (S101: No), the CPU 11a repeats S101. On the other hand, when the CPU 11a determines that an operation occurs to the BS key (S101: Yes), the CPU 11a proceeds with the process to S102.

In S102, the CPU 11a determines whether or not a sliding operation of a finger etc. of the user occurs from the BS key as the starting point. The sliding operation starting from the BS key includes, for example, an operation in which the user touches the BS key with a finger etc. and then moves the finger etc. on the touch panel 12 without releasing the finger etc. from the touch panel 12. It is noted that the direction of movement of the finger etc. to be detected can be set in advance by defining one or more directions on the touch panel 12 and configuring the CPU 11a to detect sliding operations in the defined directions. When the CPU 11a determines that a sliding operation starting from the BS key does not occur (S102: No), the CPU 11a proceeds with the process to S109. On the other hand, when the CPU 11a determines that a sliding operation starting from the BS key occurs (S102: Yes), the CPU 11a proceeds with the process to S103.

In S103, the CPU 11a sends a Shift code to the text editing software. It is noted that the Shift code is a code which enables selection of input characters displayed on the display 13 by the text editing software. For example, the Shift code corresponds to a code for enabling selection of input characters when a so-called Shift key of a keyboard is held down. In addition, in S103, the CPU 11a sends a cursor key code to the text editing software. It is noted that the cursor key code is a code for instructing the direction of movement of the character input position when characters are edited by the text editing software. The cursor key code corresponds to a code for instructing the direction of movement of the character input position when a so-called arrow key of a keyboard is pressed. As an example, a code corresponding to the left arrow key can be used for the cursor key code in the present embodiment. When the CPU 11a sends the Shift code and the cursor key code to the text editing software, the CPU 11a proceeds with the process to S104.

In S104, the CPU 11a determines whether or not the length of sliding determined in S102 increases a predetermined length and whether or not the length of sliding decreases the predetermined length. It is noted that the predetermined length is a length for increasing and decreasing the number of selected input characters displayed on the display 13 by the text editing software. It is assumed here that when a user slides a finger to the left from the BS key on the touch panel 12 the length of sliding is a straight-line distance between the BS key and the finger on the touch panel. And, when the user slide the finger to the left, that is, the user move the finger away from the BS key, the length of sliding increases. On the other hand, when the user slide the finger to the right, that is, the user move the finger towards the BS key, the length of sliding decreases. When the CPU 11a determines that the length of sliding increases or decreases the predetermined length (S104: Yes), the CPU 11a proceeds with the process to S105. On the other hand, when the CPU 11a determines that the length of sliding is less than the predetermined length (S104: No), the CPU 11a proceeds with the process to S106.

In S105, the CPU 11a sends a cursor key code to the text editing software according to the determination result of the increase or the decrease of the length of sliding in S104. In the example as described above for S104, a code corresponding to the left arrow key is sent to the text editing software when the length of sliding increases. Since the Shift code has been sent to the text editing software in S103, the function of selecting characters has been enabled in the text editing software. Therefore, when the text editing software receives a code corresponding to the left arrow key, the text editing software extends the selection range of characters to the left for the input characters displayed on the display 13. As a result, the number of selected characters increases in the text editing software. It is noted that the display 13 displays the currently selected characters with a representation different from a representation applied to the characters which are not selected currently. For example, the currently selected characters are highlighted in order to draw the user's attention. With this configuration, the currently selected characters which are subject to deletion are represented in a way different from the characters which are not selected currently. As a result, the user can easily check the selection range of the characters which are subject to deletion, even when the selection range is changed according to the sliding operation. Since the representation of the characters can be achieved using conventional techniques, the detailed descriptions of the representation processes in the mobile terminal device 10 are omitted here.

On the other hand, when the length of sliding decreases the predetermined length, a code corresponding to the right arrow key is sent to the text editing software. When the text editing software receives the code corresponding to the right arrow key, the text editing software narrows the selection range of characters to the right for the input characters displayed on the display 13. As a result, the number of selected characters decreases in the text editing software. Thus, when a series of processes in S104 and S105 is performed, the user can preferably select characters by sliding the finger to the left or to the right the predetermined length on the touch panel 12 to increase or decrease the selection range of input characters displayed on the display 13. When the CPU 11a sends a cursor key code to the text editing software, the CPU 11a proceeds with the process to S106.

In S106, the CPU 11a determines whether the sliding operation determined in S102 is continuing or not. This determination can be done by determining whether a finger etc. of the user is released from the touch panel 12 based on the touch detection result of the touch panel 12. Further, when the CPU 11a determines that the sliding operation is continuing (S106: Yes), the CPU 11a returns the process to S104. On the other hand, when the CPU 11a determines that the sliding operation is not continuing (S106: No), the CPU 11a proceeds with the process to S107. It is noted that the determination that the sliding operation is not continuing is an example of the process for detecting that the sliding operation is completed.

In S107, the CPU 11a sends a BS code to the text editing software. It is noted that the BS code is a code for deleting input a character displayed on the display by the text editing software. The BS code corresponds to a code for deleting a character when the so-called backspace key of a keyboard is pressed. Since a Shift code is sent in S103, the selection of characters is enabled in the steps subsequent to S103 in the text editing software. Therefore, when the text editing software receives the BS code, the text editing software deletes the currently selected characters. As a result, the user can select the input characters displayed on the display 13 which the user wishes to delete by the sliding operation and delete the selected characters when a series of processes from S104 through S107 are performed. When the CPU 11a sends the BS code to the text editing software in S107, the CPU 11a proceeds with the process to S108.

In S108, the CPU 11a sends a Shift cancellation code to the text editing software. It is noted that the Shift cancellation code is a code for disabling the Shift code sent to the text editing software in S103. Specifically, the Shift cancellation code is for cancelling the selection of input characters displayed on the display 13 by the text editing software. The Shift cancellation code corresponds to a code for aborting the selection of characters when the Shift key of a keyboard is released. When the process in S108 is performed, the text editing software returns to the state in which a variety of character editing processes can be performed as in the state before the processes of the flowchart as illustrated in FIG. 3 are initiated. When the CPU 11a sends the Shift cancellation code to the text editing software in S108, the CPU 11a terminates the processes of the flowchart.

As described above, when it is determined in S102 that the sliding operation starting from the BS key by the finger etc. of the user does not occur, the CPU 11a proceeds with the process to S109. In S109, the CPU 11a sends the BS code to the text editing software as in S107. When a series of processes in S101, S102 and S109 are performed, a character to the left of the cursor among the characters displayed on the display 13 is deleted in the text editing software. Since this process is similar to a conventional process for deleting a character when the BS key on the display is tapped, the detailed descriptions for this process is omitted here. When the CPU 11a sends the BS code to the text editing software in S109, the CPU 11a terminates the processes of the flowchart.

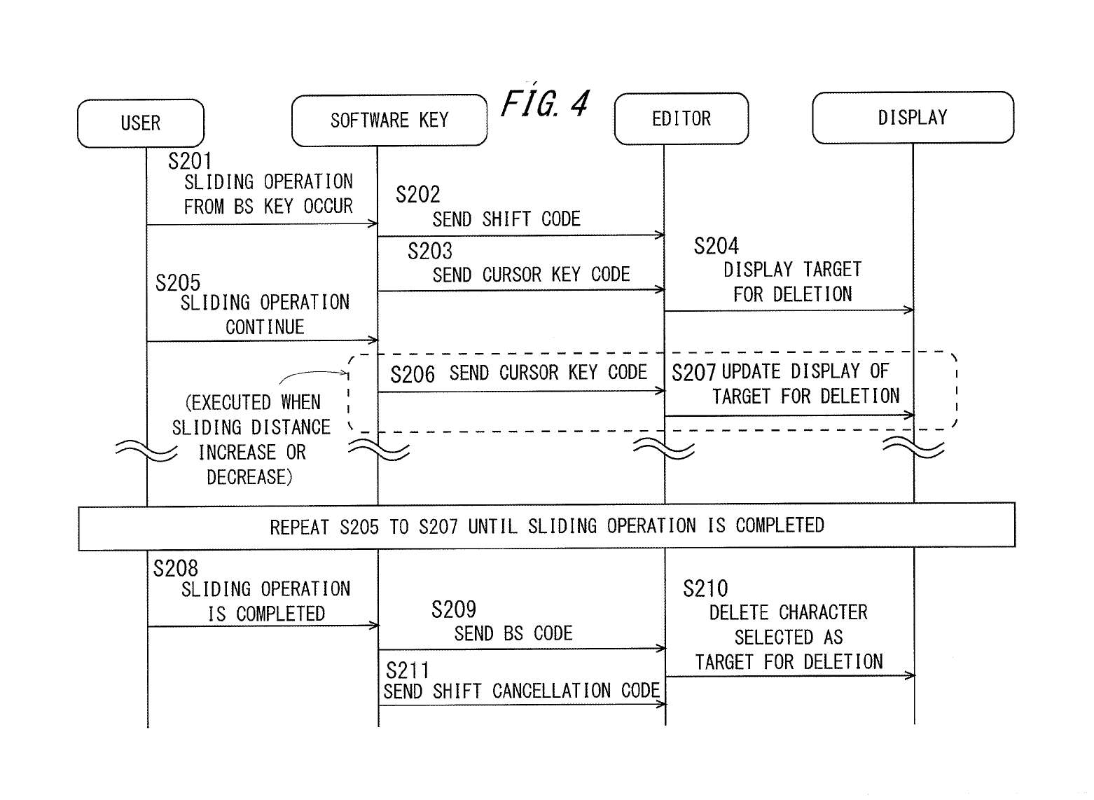

Next, FIG. 4 illustrates a timing chart in an example of the deletion processes of characters in the present embodiment. It is assumed in S201 in the present embodiment that the user touches the BS key displayed on the display 13 with a finger and performs a sliding operation with the finger placed on the touch panel 13. The user's sliding operation is processed by the software key displayed on the display 13. The processes of the software key are performed by the CPU 11a. When the sliding operation occurs, the software key sends a Shift code to the text editing software (S202). In addition, the software key sends a left arrow key code to the text editing software after the software key sends the Shift code to the text editing software (S203).

When the text editing software receives the Shift code and the left arrow key code from the software key, the text editing software selects one character to the left of the cursor among the characters displayed on the display 13. And the text editing software changes the representation of the selected character to indicate that the selected character is a target for deletion. It is noted that the representation of a character which is a target for deletion can be set using conventional techniques.

When the user continues the sliding operation performed in S201 (S205) and the sliding distance increases or decreases a predetermined distance or more, the software key sends a left arrow key code or a right arrow key code to the text editing software according to the increase or decrease of the sliding distance (S206). When the text editing software receives an arrow key code from the software key, the text editing software increases or decreases the character selection range according to the direction indicated by the received arrow key code. In addition, the text editing software refreshes the representation of the characters displayed on the display 13 to indicate that the increased or decreased character selection range is a new target for deletion (S207). It is noted that the processes in S206 and S207 are performed when the software key determines in S205 that the sliding distance increases or decreases the predetermined distance or more.

And the processes in S205 to S207 are repeated until the user finishes the sliding operation started in S201, for example, the user releases the finger used for the sliding operation from the touch panel 12. When the user finishes the sliding operation (S208), the software key determines that the user's sliding operation is terminated and sends the BS code to the text editing software (S209). When the text editing software receives the BS code, the text editing software deletes the characters selected as the target for deletion and refreshes the representation of characters displayed on the display 13 (S210). In addition, after the software key sends the BS code, the software key sends a Shift cancellation code to the text editing software (S211). When the text editing software receives the Shift cancellation code, the text editing software disables the character selection function enabled in S202.

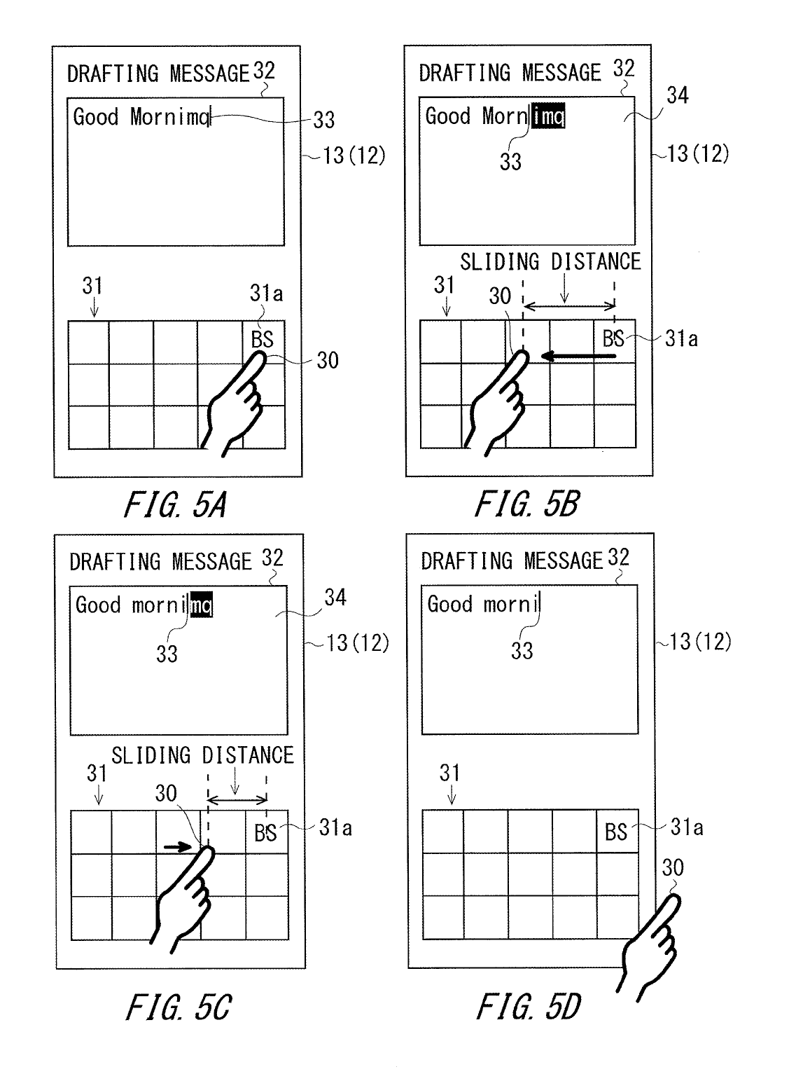

FIGS. 5A to 5D illustrates an example of the representation of characters displayed on the display 13 when the processes for deleting characters are performed in the present embodiment. In the example illustrated in FIGS. 5A to 5D, the text editing software is started in the mobile terminal device 10 and the user uses the text editing software to generate intended text body. An character representation area 32 for displaying characters is displayed on the display 13. In addition, the software key is also started in the mobile terminal device 10, and a software keyboard 31 is displayed on the display 13. Further, since the user have used the software keyboard 31 to input characters “Good mornimq”, the input characters are displayed in the character representation area 32. Moreover, a cursor 33 is displayed at the position following the input characters in the character representation area 32. It is noted that the cursor corresponds to an example of an indication unit.

In the example as illustrated in FIGS. 5A to 5D, the user deletes the last two characters “mq” from among the characters “Good mornimq” displayed in the character representation area 32 on the display 13. As illustrated in FIG. 5A, the user firstly touches the backspace key 31a of the software keyboard 31 with a finger 30, and then keeps the finger touching the backspace key without releasing the finger 30 from the touch panel 12. Next, as illustrated in FIG. 5B, the user slides the finger 30 to the left from the backspace key 31a without releasing the finger 30 from the touch panel 12.

In the example as illustrated in FIGS. 5A to 5D, the straight-line distance between the center of the backspace key 31a and the touch position of the finger 30 on the touch panel 12 is referred to as sliding distance. In the character representation area 32, characters are selected as a target for deletion according to the sliding distance measured from the position of the cursor 33 as the starting point which is displayed when the user touches the backspace key 31a with the finger 30 (see FIG. 5A). The number of characters selected as the target for deletion increases with distance between the touch position of the finger 30 on the touch panel 12 and the backspace key 31a when the user slides the finger 30 to the left from the backspace key 31a. Since the cursor 33 is used as the starting point for selecting characters, the user can move the cursor 33 to the intended position in the displayed characters and perform the sliding operation as described above to select a part of displayed characters as the target for deletion. Similarly, in the example as illustrated in FIGS. 5A to 5D, the user can also move the cursor 33 to the position after the character “d” of “Good mornimq” and perform the sliding operation as described above to select the characters “Good” as the target for deletion.

In the example as illustrated in FIG. 5B, the last characters “imq” from among the characters “Good mornimq” displayed in the character representation area 32 are selected as the target for deletion by the user's sliding operation as described above. And then the user continues the sliding operation and decrease the number of characters as the target for deletion in order to delete the last two characters “mq” in the present example. As illustrated in FIG. 5C, the user keeps the finger 30 touching the touch panel 12 and slides the finger 30 to the right toward the backspace key 31a. Thus, since the sliding distance decreases, the number of characters as the target for deletion also decreases and the last two characters “mq” are selected as the target for deletion in the character representation area 32. It is noted that although the cursor 33 is displayed before the characters as the target for deletion in FIGS. 5B and 5C, the display position of the cursor 33 is not limited to the position as illustrated in FIGS. 5B and 5C.

And then, as illustrated in FIG. 5D, the user release the finger 30 from the touch panel 12 when the last two characters “mq” are selected as the target for deletion in the character representation area 32. As a result, a series of sliding operation as illustrated in FIGS. 5A to 5C are completed, and the last two characters “mq” selected as the target for deletion are deleted in the character representation area 32. In addition, the cursor 33 is displayed on the right hand of the last character “i” of the remaining characters “Good morni”. When the sliding operation as described above is completed and the characters as the target for deletion are deleted, the user can use the software keyboard to perform various character editing operations.

Although specific embodiments are described above, the configurations described and illustrated in each configuration example can be arbitrarily modified and/or combined. For example, although the backspace key is used as the starting point of the sliding operation, any one of the other keys of the software keyboard can be used as the starting point of the sliding operation. Additionally, although the text editing software is executed in the embodiments as described above, anyone of the other software programs using the software keyboard 31 in the mobile terminal device 1 can be executed instead in the embodiments as described above.

Further, the software keyboard sends a BS code to the text editing software (S107, S209) and then sends a Shift cancellation code to the text editing software (S108, S210) in the above embodiments. However, in the case in which the text editing software is configured to maintain the selection of characters before the text editing software receives the Shift cancellation code even when the text editing software disables the character selection function as the text editing software receives the Shift cancellation code, the order for sending the BS code and Shift cancellation code can be reversed.

Moreover, although the straight-line distance between the center of the backspace key 31a and the touch position of the finger 30 on the touch panel 12 is the sliding distance in the embodiments as described above, the straight-line distance can be defined in any direction starting from the center of the backspace key 31a. In addition, although the mobile terminal device 10 with the touch panel 12 and the display 13 laminated together is used as an example of a mobile terminal device according to the embodiments, a device such as a pointing device including a so-called touch pad, in which the detection unit to detect user's touch operations and the display unit to display a software keyboard and characters are not laminated, can also be used in the above embodiments.

<<Computer Readable Recording Medium>>

It is possible to record a program which causes a computer to implement any of the functions described above on a computer readable recording medium. In addition, by causing the computer to read in the program from the recording medium and execute it, the function thereof can be provided.

The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a DVD, a DAT, an 8-mm tape, and a memory card. Of such recording media, those fixed to the computer include a hard disk and a ROM (Read Only Memory).

The technique disclosed according to the embodiments can provide an information processing apparatus to advantageously delete characters which a user intends to delete.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing apparatus, comprising:
a display unit configured to display a virtual keyboard and a character representation area for displaying a character;
a detection unit configured to detect a touch input to the virtual keyboard; and
a control unit configured to display a character in the character representation area according to the detected touch input to the virtual keyboard,
wherein when the detection unit detects a sliding operation starting from a predetermined key of the virtual keyboard, the control unit selects from among characters displayed in the character representation area at least one character according to the number of characters determined by a distance between the predetermined key and a touch position of the sliding operation and then deletes the selected character when the detention unit detects that the sliding operation is completed.

2. The information processing apparatus according to claim 1, wherein the control unit displays the selected character in the character representation area with a representation different from a representation used for displaying a character other than the selected character.

3. The information processing apparatus according to claim 1, wherein:
an indicator configured to indicate an input position of a character is displayed in the character representation area;
the control unit selects at least one character according to the number of characters determined by the distance between the predetermined key and the touch position of the sliding operation, wherein the indicator is used as a starting point for counting the number of characters determined by the distance between the predetermined key and the touch position of the sliding operation.

4. A input control method, comprising:
displaying, by a computer, a virtual keyboard and a character representation area for displaying a character;
detecting, by the computer, a touch input to the virtual keyboard; and
displaying, by the computer, a character in the character representation area according to the detected touch input to the virtual keyboard,
wherein when a sliding operation starting from a predetermined key of the virtual keyboard is detected, at least one character is selected from among characters displayed in the character representation area according to the number of characters determined by a distance between the predetermined key and a touch position of the sliding operation and then the selected character is deleted when it is detected that the sliding operation is completed.

5. The input control method according to claim 4, wherein the selected character is displayed in the character representation area with a representation different from a representation used for displaying a character other than the selected character.

6. The input control method according to claim 4, the method further comprising:
displaying, by the computer, an indicator configured to indicate an input position of a character in the character representation area,
wherein at least one character is selected according to the number of characters determined by the distance between the predetermined key and the touch position of the sliding operation, wherein the indicator is used as a starting point for counting the number of characters determined by the distance between the predetermined key and the touch position of the sliding operation.

7. A non-transitory computer-readable recording medium storing a program that causes a computer to execute a process comprising:
displaying a virtual keyboard and a character representation area for displaying a character;
detecting a touch input to the virtual keyboard; and
displaying a character in the character representation area according to the detected touch input to the virtual keyboard,
wherein when a sliding operation starting from a predetermined key of the virtual keyboard is detected, at least one character is selected from among characters displayed in the character representation area according to the number of characters determined by a distance between the predetermined key and a touch position of the sliding operation and then the selected character is deleted when it is detected that the sliding operation is completed.

8. The non-transitory computer-readable recording medium storing the program that causes the computer to execute the process according to claim 7, wherein the selected character is displayed in the character representation area with a representation different from a representation used for displaying a character other than the selected character.

9. The non-transitory computer-readable recording medium storing the program that causes the computer to execute the process according to claim 7, the process further comprising:
displaying an indicator configured to indicate an input position of a character in the character representation area,
wherein at least one character is selected according to the number of characters determined by the distance between the predetermined key and the touch position of the sliding operation, wherein the indicator is used as a starting point for counting the number of characters determined by the distance between the predetermined key and the touch position of the sliding operation.
